(19) United States
(12) Patent Application Publication
(10) Pub. No.: US 2006/0197329 A1
(43) Pub. Date: Sep. 7, 2006

(54) Airbag

(75) Inventors: Masakazu Asano, Aichi-ken (JP); Mitsuhiro Kikuta, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/365,619

(22) Filed: Mar. 2, 2006

(30) Foreign Application Priority Data
Mar. 7, 2005 (JP) 2005-062255

(51) Int. Cl. B60R 21/23; B60R 21/237

(52) U.S. Cl. 280/743.1; 280/731; 428/375; 280/743.2

(57) ABSTRACT

The airbag of the present invention is formed by sewing up a set of base cloths with a sewing thread into a bag shape inflatable with inflation gas. The sewing thread is impregnated with a lubricant containing less than 30 weight percent silicone oil. The lubricant content of the sewing thread is in a range of 1.0 to 2.0 weight percent.

The present application claims priority from Japanese Patent Application No. 2005-062255 of Asano et al., filed on Mar. 7, 2005, the disclosure of which is hereby incorporated into the present application by reference.

### BACKGROUND OF THE INVENTION

1. Field of the Invention

The present invention relates to an airbag formed into a generally bag shape to be inflatable with inflation gas.

2. Description of Related Art

In the prior art, Japanese Patent Laid-Open No. 2002-283941 is illustrative of an airbag formed by sewing up a set of base cloths with sewing thread, which base cloths are woven of polyamide yarn or the like, into a bag shape.

Airbags are usually manufactured by high-speed sewing machines. Sewing threads used for such a sewing machine are impregnated with lubricant containing silicone oil, in order to prevent a high-speed moving needle from being heated due to frictional heat generated between the needle and base cloths, and in order to lubricate sewing threads against the base cloths.

However, when using such impregnated sewing threads, the lubricant accumulates in a bobbin case, thread tension disc, or thread tension adjusting knob. These members have to be cleaned periodically in order to remove the accumulated lubricant. In addition, high-cost of silicone oil contained in the lubricant has increased manufacturing cost of the airbag.

### SUMMARY OF THE INVENTION

An object of the present invention is to provide an airbag conducive to keep high productivity, and to reduce manufacturing processes and cost.

The object of the present invention is achieved by an airbag which is formed by sewing up a set of base cloths with a sewing thread into a bag shape inflatable with inflation gas, wherein:

the sewing thread is impregnated with a lubricant containing less than 30 weight percent silicone oil; and

a lubricant content of the sewing thread is in a range of 1.0 to 2.0 weight percent of the sewing thread.

Preferably, the lubricant contains 25 weight percent and above and less than 30 weight percent silicone oil.

More preferably, the lubricant content of the sewing thread is in a range of 1.25 to 1.75 weight percent of the sewing thread.

Moreover, the weight ratio of the silicone oil against the set of base cloths is in a range of 0.01 to 0.05 weight percent.

In addition, it is desired that:

the airbag is used for an airbag apparatus for steering wheel;

the set of base cloths includes seven base cloths: a vehicle body side base cloth having a generally circular shape and deployed toward the steering wheel upon airbag inflation, and provided with a gas inlet port for admitting inflation gas; an occupant side base cloth having the generally same contour as the vehicle body side base cloth and deployed toward a vehicle occupant upon airbag inflation; four reinforcing cloths for reinforcing the gas inlet port periphery of the vehicle body side base cloth; and a tether base cloth for constructing a tether which serves to regulate a clearance between the vehicle body side base cloth and the occupant side base cloth upon airbag inflation; and

outer edges of the vehicle body side base cloth and occupant side base cloth; a region in the gas inlet port periphery in the vehicle body side base cloth and the reinforcing cloths; leading ends of two main bodies of the tether base cloth which main bodies construct the tether and leading ends of two extensions of one of the reinforcing cloths; are sewn up by the sewing thread, respectively, whereby forms the airbag.

### BRIEF DESCRIPTION OF DRAWINGS

FIG. 1 is a plan view of a steering wheel on which an airbag apparatus employing an airbag embodying the present invention is mounted;

FIG. 2 is a schematic section of the steering wheel of FIG. 1;

FIG. 3 is a plan view of the developed airbag of the embodiment;

FIG. 4 is a bottom view of the developed airbag of the embodiment;

FIG. 5 shows schematic exploded perspective views of base cloths as components of the airbag of the embodiment; and

FIG. 6 is a schematic section of the inflated airbag of the embodiment.

### DESCRIPTION OF PREFERRED EMBODIMENT

A preferred embodiment of the present invention is described below with reference to the accompanying drawings. However, the invention is not limited to the embodiments disclosed herein. All modifications within the appended claims and equivalents relative thereto are intended to be encompassed in the scope of the claims. For example, although the embodiment is described as applied to an airbag 20 used in an airbag apparatus M for steering wheel, the present invention is applicable to an airbag for an airbag apparatus for front passenger's seat, an airbag for a side impact airbag apparatus, or the like, on condition that the airbag is manufactured by sewing up a set of base cloths with sewing thread.

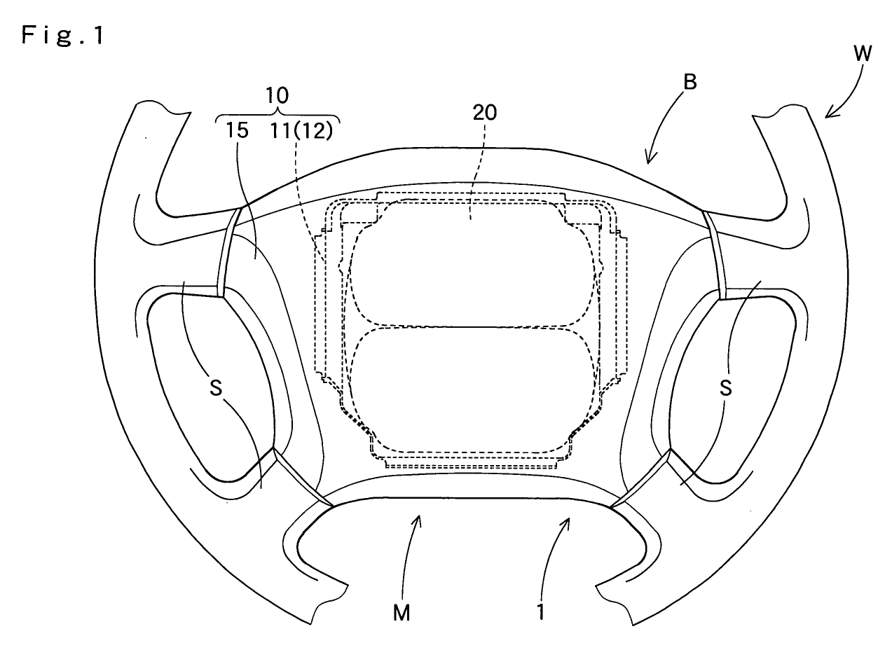

As shown in FIG. 1, the airbag 20 embodying the present invention is used in the airbag apparatus M mounted over a boss B in the center of steering wheel W. The steering wheel W includes a ring R, a boss B and four spokes S. The ring R is for holding during steering operation. The boss B is disposed at the center of the steering wheel W and is joined with the unillustrated steering shaft. The spokes S connect the ring R and the boss B. The steering wheel W includes, as its components, an airbag apparatus M and a steering wheel body 1.

The steering wheel body 1 includes a steering wheel core 2, a coating layer 3 and a lower cover 4. The core 2 is made from aluminum alloy or the like, and has such a shape as to connect the ring R, the boss B and the spokes S one another. The coating layer 3 is made from synthetic resin and covers the core 2 in the ring R and part of the spokes S at the side of the ring R. The lower cover 4 is made from synthetic resin and is disposed below the boss B.

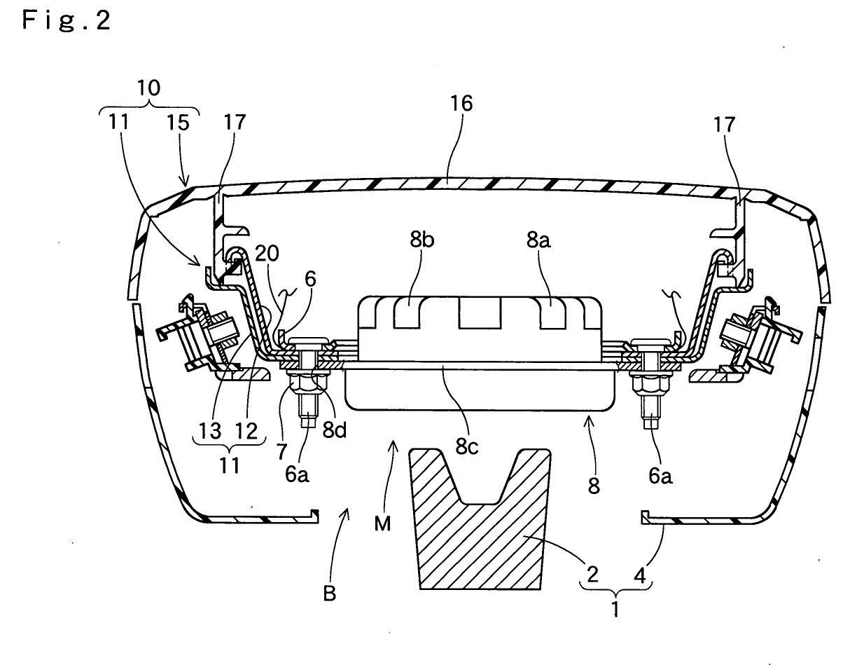

As shown in FIG. 2, the airbag apparatus M includes a folded airbag 20, an inflator 8 for supplying the airbag 20 with inflation gas, and a case 10 for housing and holding the airbag 20 and the inflator 8.

The inflator 8 includes a body 8a and a flange 8c. The body 8a is generally columnar in shape, and is provided at the upper region thereof with a plurality of gas discharge ports 8b for discharging inflation gas. The flange 8c has a generally square plate shape and is projected from the outer circumference of the body 8a. The flange 8c has insert holes 8d for inserting bolts 6a protruded from a later-described retainer 6.

The retainer 6 is made of sheet metal and has a generally square annular shape, and has bolts 6a protruded downward from four corners thereof. The retainer 6 serves to hold the periphery of later-described gas inlet port 22 of the airbag 20, while allowing the bolts 6a protruded from the flange 8c of the inflator 8 through the periphery of the gas inlet port 22 and later-described bag holder 11. The retainer 6 attaches the airbag 20 to the bag holder 11 of the case 10 by fastening the bolts 6a into nuts 7.

As best shown in FIG. 2, the case 10 includes a bag holder 11 of sheet metal, and a pad 15 of synthetic resin as an airbag cover. The bag holder 11 includes a holder plate 12 having a generally rectangular parallelepiped shape opened upward, and a backup plate 13 for clasping the pad 15 in cooperation with the holder plate 12. The backup plate 13 is provided with unillustrated brackets connected to the core 2 of the steering wheel body 1. The pad 15 includes a lid 16 for covering the upper side of the boss B, and a side wall 17 protruded downward from the lower side of an edge part of the lid 16 in a generally square cylindrical shape. In a region of the lid 16 encircled by the side wall 17 are two doors (reference numerals omitted) openable toward the front and rear directions of the steering wheel W when the airbag 20 expands. The side wall 17 is clamped at the lower end by the holder plate 12 and the backup plate 13 constituting the bag holder 11, thus is held by the bag holder 11.

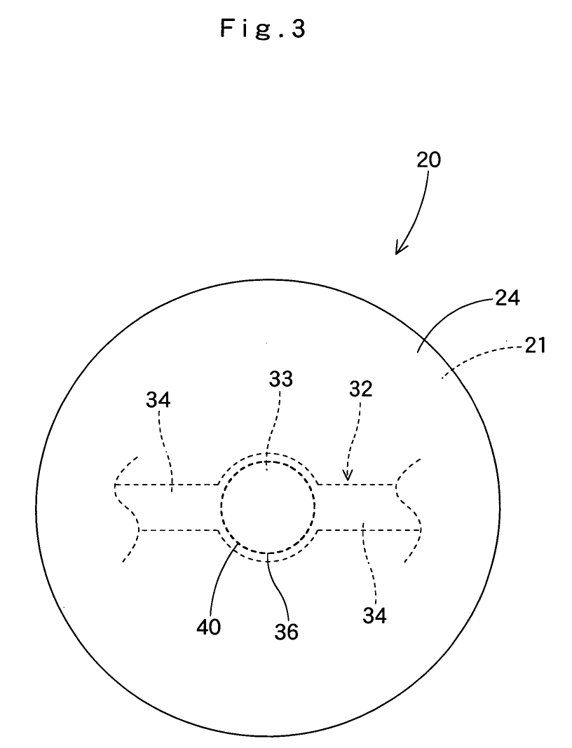

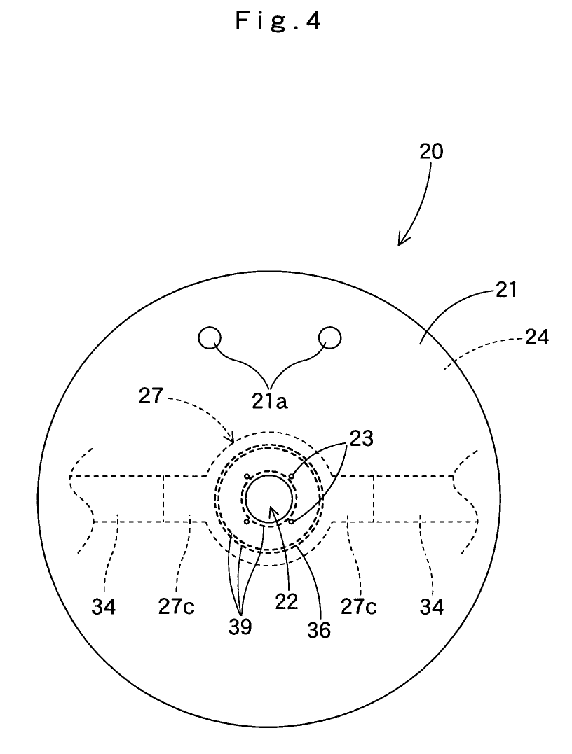

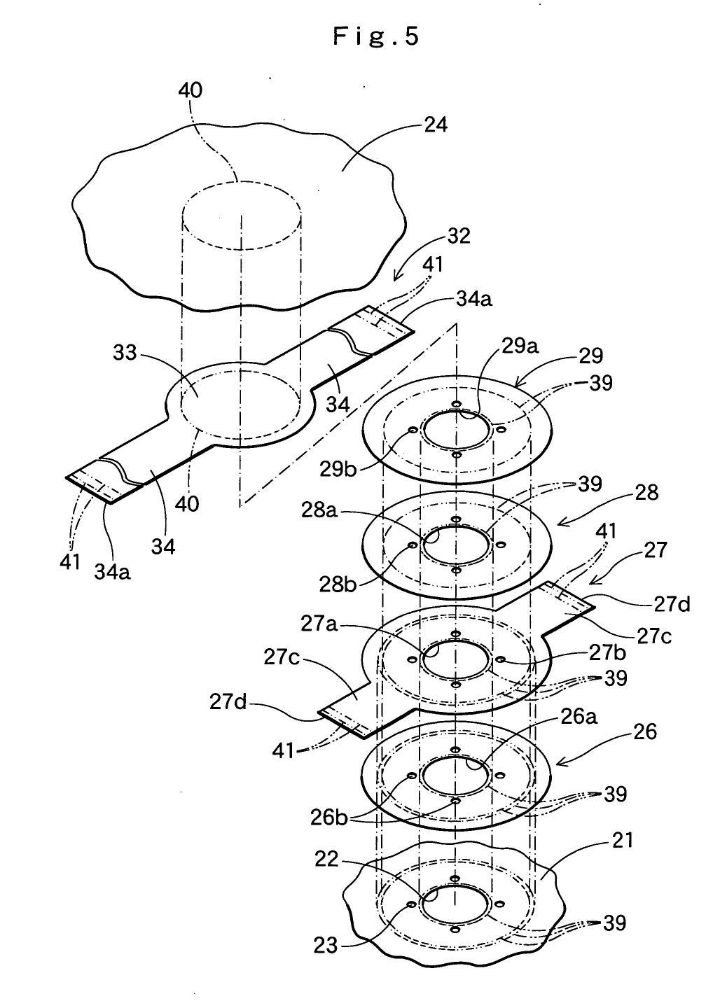

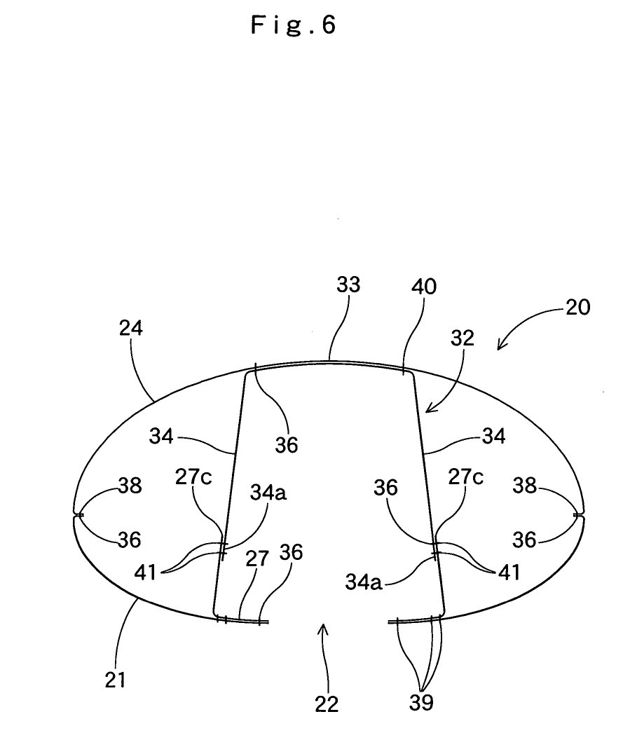

The airbag 20 is formed of flexible woven fabric of polyamide, polyester or the like. In this specific embodiment, as shown in FIGS. 3 to 6, the airbag 20 is composed of seven base cloths: a vehicle body side base cloth 21 having a generally circular shape and deployed toward the steering wheel W upon airbag inflation; an occupant side base cloth 24 having the generally same contour as the vehicle body side base cloth 21 and deployed toward the occupant upon airbag inflation; four reinforcing cloths 26, 27, 28 and 29 for reinforcing the periphery of later-described gas inlet port 22 in the vehicle body side base cloth 21; and a tether base cloth 32 for constructing a tether 31 which tether serves to regulate a clearance between the vehicle body side base cloth 21 and the occupant side base cloth 24 when the airbag is completely inflated. The vehicle body side base cloth 21 is provided, in its center vicinity, with a gas inlet port 22 opened in a round shape for admitting inflation gas from the inflator 8 inside the airbag, and around the gas inlet port 22, with mounting holes 23 for inserting the bolts 6a of the retainer 6 therethrough. The vehicle body side base cloth 21 further includes vent holes 21a, as shown in FIG. 4.

The reinforcing cloths 26, 27, 28 and 29 are sewn to the periphery of the gas inlet port 22, and have generally circular shapes provided with openings 26a, 27a, 28a and 29a, respectively, corresponding to the inlet port 22. Each of the reinforcing cloths 26, 27, 28 and 29 is also provided with apertures 26b, 27b, 28b and 29b, respectively, corresponding to the mounting holes 23. Therein forcing cloth 27 further includes band-shaped extensions 27c extending symmetrically toward left and right directions. Leading ends 27d of the extensions 27c are coupled with leading ends 34a of later-described main bodies 34 of the tether base cloth 32, thereby forms the tether 31.

The tether base cloth 32 includes a generally circular anchor region 33 joined to the occupant side base cloth 24, and main bodies 34. Leading ends 34a of the main bodies 34 will be coupled with the leading ends 27d of the extensions 27c of the reinforcing cloth 27 so as to form the tether 31. The main bodies 34 extend symmetrically toward left and right directions.

The airbag 20 is so formed into a bag shape as to be inflatable with inflation gas, utilizing a sewing thread 36, by sewing up predetermined regions in the base cloths 21, 24, 26, 27, 28, 29, and 32. More specifically, in the embodiment, sewn lines by the sewing thread 36 are formed in a generally annular region 38 to join outer edges of the vehicle body side base cloth 21 and occupant side base cloth 24, in three annular regions 39 concentrically disposed to connect the reinforcing cloths 26, 27, 28, and 29 to the vehicle body side base cloth 21 in the periphery of the gas inlet port 22, in a generally annular region 40 to connect the anchor region 33 of the tether base cloth 32 to the occupant side base cloth 24, and in a generally straight regions 41 to connect the leading ends 34a of the main bodies 34 of the tether base cloth 32 and the leading ends 27d of the extensions 27c in the reinforcing cloth 27.

The sewing thread 36 is made by caking numerous filaments of polyamide or the like with paraffin or the like, not by twisting, in order to secure efficiency of high-speed sewing machines. In the specific embodiment, the sewing thread 36 is made by caking 72 pieces of 6,6 Nylon filaments by paraffin, not by twisting.

Moreover, the sewing thread 36 used in the embodiment is an impregnated thread impregnated with a lubricant containing silicone oil, which, more specifically, is a mixture of silicone oil and mineral oil. It is preferable that the lubricant contains less than 30 weight percent (more desirably, 25 weight percent and above, and less than 30 weight percent) silicone oil. It is because silicone oil costs more than mineral oil, and it is preferable to use fewer amount of silicone oil. Using a lubricant containing more than 30 weight percent silicone oil will not be conducive to cost-reduction. On the contrary, if the content of silicone oil is less than 25 weight percent, frictional resistance in the sewing work will be considerably increased. In the light of heat-resistance, lubricity and so on, the silicone oil used for the present invention is preferably dimethyl silicone oils.

In the preferred embodiment, lubricant content impregnated into the sewing thread 36 is set to 1.0 to 2.0 weight percent (more desirably, 1.25 to 1.75 weight percent). The lubricant content impregnated into the thread 36 is preferably suppressed since the lubricant impregnated into the sewing thread accumulates in such parts of sewing machine as bobbin case in the course of sewing work, and therefore needs to be removed therefrom periodically. If the lubricant content impregnated into the sewing thread 36 surpasses 2.0 weight percent, cleaning of the accumulated lubricant needs to be made at short intervals. On the contrary, if the lubricant content is less than 1.0 weight percent, insufficient lubricant content can cause adverse affects such as thread breakage during the sewing work. Therefore, it is preferable to impregnate 1.0 to 2.0 weight percent lubricant into the sewing thread 36.

Now is described how to manufacture the airbag 20 embodying the present invention. The airbag 20 is manufactured by a high-speed industrial sewing machine. Firstly, in order to form the sewn line 40, the anchor region 33 of the tether base cloth 32 is sewn to the occupant side base cloth 24 with the sewing thread 36. Subsequently, the reinforcing cloths 26, 27, 28 and 29 are sewn to the vehicle body side base cloth 21 with the thread 36 to form the sewn line 39. Thereafter, punching work of the gas inlet port 22 and the mounting holes 23 is applied to the base cloth 21 and the reinforcing cloths 26, 27, 28 and 29. Alternatively, the inlet port 22 (26a, 27a, 28a and 29a) and the mounting holes 23 (26b, 27b, 28b and 29b) may be preliminarily provided in the base cloths 21, 26, 27, 28 and 29. The vent holes 21a in the base cloth 21 may also be punched out either preliminarily in each base cloth or at the same time of punching work of the gas inlet port 22 and the mounting holes 23.

Thereafter, the vehicle body side base cloth 21 and the occupant side base cloth 24 are laid one over the other such that the outer surfaces confront each other, and the outer edges thereof are sewn up with the sewing thread 36 to form the sewn line 38. Then the airbag 20 is reversed inside out from the inlet port 22 such that allowances of the sewn region 38 may not appear on the outer surface. Subsequently, the leading ends 27d of the extensions 27c in the reinforcing cloth 27 and the leading ends 34a of the main bodies 34 in the tether base cloth 32 are taken out of the gas inlet port 22, and corresponding ends 27d and 34a are laid one over the other and sewn up with the thread 36 to form the sewn lines 41. Thus the airbag 20 is completed.

The airbag 20 thus manufactured is used to assemble the airbag apparatus M. Firstly, the retainer 6 is placed inside the airbag 20 such that the bolts 6a protrude from the mounting holes 23, and the airbag 20 is folded up from flatly developed state. After the folding-up, unillustrated breakable wrapping members are wound around the airbag for keeping the folded-up configuration.

Subsequently, the folded-up airbag 20 is located on the holder plate 12 of the bag holder 11 such that the bolts 6a of the retainer 6 project from the holder plate 12. Then the pad 15 is placed over the airbag 20 to be retained by the holder plate 12. Then the backup plate 13 is placed below the holder plate 12 such that the side wall 17 of the pad 15 is clasped between the holder plate 12 and the backup plate 13, thereby the pad 15 is held by the bag holder 11. At this time, the bolts 6a of the retainer 6 protrude from the backup plate 13.

Then the body 8a of the inflator 8 is inserted into the gas inlet port 22 from the lower side through the bag holder 11, and the bolts 6a of the retainer 6 are protruded downward from the insert holes 8d of the flange 8c of the inflator 8. If then the nuts 7 are fastened with the bolts 6a, the airbag 20, the bag holder 11 and the inflator 8 are assembled into a unit, thereby complete the assembly of an airbag apparatus M.

Then by connecting the core 2 of the boss B of the steering wheel body 1 to the unillustrated steering shaft, and by utilizing the unillustrated brackets of the bag holder 11, the airbag apparatus M is mounted on the steering wheel W.

If inflation gas is discharged from the gas discharge ports 8b of the inflator body 8a after the mounting of the steering wheel Won the vehicle, the folded airbag 20 breaks predetermined regions of the pad 15 and inflates largely.

Now comparison is made for an airbag of the preferred embodiment that meets the requirements of the present invention, and a conventional airbag. The sewing thread used in the embodiment is that which is formed by impregnating 1.5 weight percent lubricant which lubricant is a mixture of 2:8 weight ratio dimethyl silicone oil and mineral oil into a material thread formed by caking 72 pieces of 6,6 Nylon filaments by paraffin, not by twisting. The thread is used to sew up a set of 6,6 Nylon base cloths cut in predetermined shapes by industrial sewing machine, so as to manufacture the airbag of the embodiment. In the preferred embodiment, weight ratio of the silicone oil against the set of base cloths is 0.03 weight percent (total amount of the set of base cloths; 200 g, length of the used sewing thread; 10 m).

A sewing thread used in a comparative example, i.e., a conventional airbag, is that which is formed by impregnating 3.0 weight percent lubricant which lubricant is a mixture of 45:55 weight ratio dimethyl silicone oil and mineral oil into the same material thread as the preferred embodiment. Then the same base cloths as in the preferred embodiment are sewn up by the same sewing machine to form an airbag of the comparative example. In the comparative example, weight ratio of the silicone oil against the set of base cloths is 0.1 weight percent.

In each sewing machine usually manufacturing about 1,600 airbags a day, the sewing machine for manufacturing the conventional airbags needs to be cleaned about once a week to remove the lubricant accumulated in a bobbin case, whereas the frequency of cleaning of the sewing machine for manufacturing the airbags of the embodiment is reduced to once a month. Moreover, although the sewing thread used in the preferred embodiment contains reduced amount of lubricant in comparison with that in the comparative example, the lubricity of the thread against the base cloths is kept good, so that productivity of the airbags is maintained.

To summarize the effect of the airbag of the embodiment, since the sewing thread contains fewer amount of lubricant compared with a conventional airbag, the frequency of cleaning of the lubricant accumulated in parts of sewing machines is considerately lessened. Moreover, since the amount of silicone oil contained in the lubricant used in the embodiment is approximately 2/9 of that in conventional airbags, the manufacturing cost of the airbags is reduced in comparison with conventional airbags.

Therefore, the airbag of the embodiment conduces to maintain high productivity, and reduce manufacturing processes and cost.

What is claimed is:

1. An airbag formed by sewing up a set of base cloths with a sewing thread into a bag shape inflatable with inflation gas, wherein:
the sewing thread is impregnated with a lubricant containing less than 30 weight percent silicone oil; and
a lubricant content of the sewing thread is in a range of 1.0 to 2.0 weight percent of the sewing thread.

2. The airbag according to claim 1, wherein:
the lubricant contains 25 weight percent and above and less than 30 weight percent silicone oil.

3. The airbag according to claim 1, wherein the lubricant content of the sewing thread is in a range of 1.25 to 1.75 weight percent of the sewing thread.

4. The airbag according to claim 1, wherein a weight ratio of the silicone oil against the set of base cloths is in a range of 0.01 to 0.05 weight percent.

5. The airbag according to claim 1, wherein:
the airbag is used for an airbag apparatus for steering wheel;
the set of base cloths includes seven base cloths: a vehicle body side base cloth having a generally circular shape and deployed toward the steering wheel upon airbag inflation, and provided with a gas inlet port for admitting inflation gas;
an occupant side base cloth having the generally same contour as the vehicle body side base cloth and deployed toward a vehicle occupant upon airbag inflation; four reinforcing cloths for reinforcing the gas inlet port periphery of the vehicle body side base cloth; and a tether base cloth for constructing a tether which serves to regulate a clearance between the vehicle body side base cloth and the occupant side base cloth upon airbag inflation; and
outer edges of the vehicle body side base cloth and occupant side base cloth; a region in the gas inlet port periphery in the vehicle body side base cloth and the reinforcing cloths;
leading ends of two main bodies of the tether base cloth which main bodies construct the tether and leading ends of two extensions of one of the reinforcing cloths; are sewn up by the sewing thread, respectively, whereby forms the airbag.
